(19) United States
(12) Patent Application Publication
(10) Pub. No.: US 2016/0098090 A1
(43) Pub. Date: Apr. 7, 2016

(54) KINETIC USER INTERFACE

(71) Applicant: BIOGAMING LTD., Petah-Tikva (IL)

(72) Inventors: David Moshe KLEIN, Petach Tikva (IL); Eytan SABARI MAJAR, Karmel Yosef (IL)

(21) Appl. No.: 14/785,874

(22) PCT Filed: Apr. 17, 2014
(86) PCT No.: PCT/IL2014/050366

§ 371 Date: Oct. 21, 2015

(30) Foreign Application Priority Data
Apr. 21, 2013 (GB) 1307168.3

(51) Int. Cl. G06F 3/01; G06T 7/20; G06K 9/00

(52) U.S. Cl. CPC G06F 3/017; G06K 9/00342; G06T 7/20; G06T 2207/30196

(57) ABSTRACT

A computerized kinetic control system comprising: a kinetic sensor; a display device; and a hardware processor configured to: (a) display, using said display device, a GUI (Graphic User Interface) menu comprising at least two options being disposed away from a center of said display device and at different polar angles relative to the center of said display device, (b) detect, using said kinetic sensor, motion of a limb of a user, and (c) select a first option of the at least two options, wherein the selecting is based on a correspondence between a direction of the motion detected and a polar angle of the first option relative to the center of the display device.

### FIELD OF THE INVENTION

The invention relates to a kinetic user interface.

### BACKGROUND

Decline in physical function is often associated with age-related impairments to overall health, or may be the result of injury or disease. Such a decline contributes to parallel declines in self-confidence, social interactions and community involvement. People with motor disabilities often experience limitations in fine motor control, strength, and range of motion. These deficits can dramatically limit their ability to perform daily tasks, such as dressing, hair combing, and bathing, independently. In addition, these deficits, as well as pain, can reduce participation in community and leisure activities, and even negatively impact occupation.

Participating in and complying with physical therapy, which usually includes repetitive exercises, is an essential part of the rehabilitation process which is aimed to help people with motor disabilities overcome the limitations they experience. However, it has been argued that most of the people with motor disabilities do not perform the exercises as recommended. People often cite a lack of motivation as an impediment to them performing the exercises regularly. Furthermore, the number of exercises in a therapy session is oftentimes insufficient. During rehabilitation, the therapist usually personally provides physical assistance and monitors whether each student's movements are reaching a specific standard. Thus, the therapist can only rehabilitate one patient at a time, or a small group of patients at most. Patients often lack enthusiasm to participate in the tedious rehabilitation process, resulting in continued muscle atrophy and insufficient muscle endurance.

Also, it is well known that adults and especially children get bored repeating the same movements. This can be problematic when an adult or a child has to exercise certain muscles during a post-trauma rehabilitation period. For example, special exercises are typically required after a person breaks his or her arm. It is hard to make this repetitive work interesting. Existing methods to help people during rehabilitation include games to encourage people, and especially children, to exercise more.

Therefore, it is highly advantageous for patients to perform rehabilitative physical therapy at home, using techniques to make repetitive physical exercises more entertaining. Uses of video games technologies are beginning to be explored as a commercially available means for delivering training and rehabilitation programs to patients in their own homes.

U.S. Pat. No. 6,712,692 to Basson et al. discloses a method for gathering information about movements of a person, which could be an adult or child. This information is mapped to one or more game controller commands. The game controller commands are coupled to a video game, and the videogame responds to the game controller commands as it would normally.

U.S. Pat. No. 7,996,793 to Latta et al. discloses Systems, methods and computer readable media for gesture recognizer system architecture. A recognizer engine is provided, which receives user motion data and provides that data to a plurality of filters. A filter corresponds to a gesture, which may then be tuned by application receiving information from the gesture recognizer so that the specific parameters of the gesture-such as arm acceleration for a throwing gesture may be set on a per-application level, or multiple times within a single application. Each filter may output to an application using it a confidence level that the corresponding gesture occurred, as well as further details about the user motion data.

U.S Patent Application No. 2012/0190505A1 to Shavit et al. discloses a system for monitoring performance of a physical exercise routine comprises a Pilates exercise device enabling a user to perform the physical exercise routine, a plurality of motion and position sensors for generating sensory information that includes at least position and movements of a user performing the physical exercise routine; a database containing routine information representing at least an optimal execution of the physical exercise routine; a training module configured to separate from sensory information at least appearance of the Pilates exercise device, compare the separated sensory information to the routine information to detect at least dissimilarities between the sensory information and the routine information, wherein the dissimilarities indicate an incorrect execution of the physical exercise routine, the training module is further configured to feedback the user with instructions related to correcting the execution of the physical exercise routine by the user; and a display for displaying the feedback.

Smith et al. (2012) disclose an overview of the main videogame console systems (Nintendo Wii™, Sony Playstation® and Microsoft Xbox®) and discussion of some scenarios where they have been used for rehabilitation, assessment and training of functional ability in older adults, in particular, two issues that significantly impact functional independence in older adults are injury and disability resulting from stroke and falls. See S. T. Smith, D. Schoene, The use of Exercise-based Videogames for Training and Rehabilitation of Physical Function in Older Adults, Aging Health, 2012; 8(3):143-252.

Ganesan et al, (2012) disclose a project that aims to find the factors that play an important role in motivating older adults to maintain a physical exercise routine, a habit recommended by doctors but difficult to sustain. The initial data gathering includes an interview with an expert in aging and physical therapy, and a focus group with older adults on the topics of exercise and technology. Based on these data, an early prototype game has been implemented for the Microsoft Kinect that aims to help encourage older adults to exercise. The Kinect application has been tested for basic usability and found to be promising. Next steps include play-tests with older adults, iterative development of the game to add motivational features, and evaluation of the game's success in encouraging older adults to maintain an exercise regimen. See S. Ganesan, L. Anthony, Using the Kinect to encourage older adults to exercise: a prototype, in Extended Abstracts of the ACM Conference on Human Factors in Computing Systems (CHI'2012), Austin, Tex., 5 May 2012, p.2297-2302.

Lange et al. (2011) disclose that the use of the commercial video games as rehabilitation tools, such as the Nintendo WiiFit, has recently gained much interest in the physical therapy arena. Motion tracking controllers such as the Nintendo Wiimote are not sensitive enough to accurately measure performance in all components of balance. Additionally, users can figure out how to “cheat” inaccurate trackers by performing minimal movement (e.g. wrist twisting a Wiimote instead of a full arm swing). Physical rehabilitation requires accurate and appropriate tracking and feedback of performance. To this end, applications that leverage recent advances in commercial video game technology to provide full-body control of animated virtual characters are developed. A key component of the approach is the use of newly available low cost depth sensing camera technology that provides markerless full-body tracking on a conventional PC. The aim of the research was to develop and assess an interactive game-based rehabilitation tool for balance training of adults with neurological injury. See B. Lange, C. Y. Chang, E. Suma, B. Newman, A. S. Rizzo, M. Bolas, Development and evaluation of low cost game-based balance rehabilitation tool using the Microsoft Kinect sensor, 33rd Annual International Conference of the IEEE EMBS, 2011.

Using body gestures to perform “administrative” actions (and not necessarily for gaming activity), for example navigation through menus, directories etc., within an environment of a motion recognition device, has recently gained momentum, as these devices are becoming more and more common.

Burke (2011) discloses a use of motion control to navigate a common everyday computer application. More specifically the creation of a new graphical user interface design for accessing file systems that can be successfully navigated using only the Microsoft Kinect. The goal is to create a design that utilizes the Kinect's ability to understand depth and space and be able to perform common operations using only skeletal tracking. Through careful planning and several iterations the best design appears to be that of a ring. A ring can be quickly traversed and can show a direct relationship between files and directories. The best means of utilizing skeletal tracking is by comparing joint locations at certain times. For example the left hand being higher than the right will select the file the user is currently closest to. For the most part the movement choices made for different operations are easy to learn and intuitive to the design decided upon. However, issues still exist with using motion capture. The depth maps created are noisy and precise movements are nearly impossible. Even so the increased accessibility of motion capture devices is elevating their importance in the role of future computer applications. See N. Burke, Using Movement to Navigate Through a File System Contained Within a 3D Environment, Senior project. University of Florida, April 2011.

Boulos et al. (2011) disclose a use of depth sensors such as Microsoft Kinect and ASUS Xtion to provide a natural user interface (NUI) for controlling 3-D (three-dimensional) virtual globes such as Google Earth (including its Street View mode), Bing Maps 3D, and NASA World Wind. The paper introduces the Microsoft Kinect device, briefly describing how it works (the underlying technology by PrimeSense), as well as its market uptake and application potential beyond its original intended purpose as a home entertainment and video game controller. The different software drivers available for connecting the Kinect device to a PC (Personal Computer) are also covered, and their comparative pros and cons briefly discussed. We survey a number of approaches and application examples for controlling 3-D virtual globes using the Kinect sensor, then describe Kinoogle, a Kinect interface for natural interaction with Google Earth, developed by students at Texas A&M University. Readers interested in trying out the application on their own hardware can download a Zip archive (included with the manuscript as additional files 1, 2, &3) that contains a ‘Kinnogle installation package for Windows PCs’. Finally, we discuss some usability aspects of Kinoogle and similar NUIs for controlling 3-D virtual globes (including possible future improvements), and propose a number of unique, practical ‘use scenarios’ where such NUIs could prove useful in navigating a 3-D virtual globe, compared to conventional mouse/3D mouse and keyboard-based interfaces. See M. K. Boulos, B. J. Blanchard, C. Walker, J. Montero, A. Tripathy, R. Gutierrez-Osuna, Web GIS in practice X: a Microsoft Kinect natural user interface for Google Earth navigation, International Journal Of Health Geographies, 2011.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, computerized kinetic control system comprising: a kinetic sensor; a display device; and a hardware processor configured to: (a) display, using said display device, a GUI (Graphic User Interface) menu comprising at least two options being disposed away from a center of said display device and at different polar angles relative to the center of said display device, (b) detect, using said kinetic sensor, motion of a limb of a user, and (c) select a first option of the at least two options, wherein the selecting is based on a correspondence between a direction of the motion detected and a polar angle of the first option relative to the center of the display device.

There is further provided, in accordance with an embodiment, a method for controlling a GUI (Graphic User Interface) menu, the method comprising using at least one hardware processor for: displaying, on a display device, a GUI menu comprising at least two options being disposed away from a center of the display device and at different polar angles relative to the center of the display device; detecting, using a kinetic sensor, motion of a limb of a user; and selecting a first option of the at least two options, wherein the selecting is based on a correspondence between a direction of the directional motion detected and a polar angle of the first option relative to the center of the display device.

In some embodiments, said kinetic sensor is a motion-sensing camera.

In some embodiments, said hardware processor is further configured to trigger the display of the GUI menu responsive to the user positioning the limb in a predetermined posture.

In some embodiments, said hardware processor is further configured to display a cursor in said GUI menu and to correlate a motion of the cursor with the motion of the limb.

In some embodiments, said hardware processor is further configured to force the display of the cursor to be at an initial position at the center of said display device.

In some embodiments, the limb is an arm.

In some embodiments, the predetermined posture comprises standing upright and extending the arm straight forward.

In some embodiments, hardware processor is further configured to select the first option following a delay provided to enable the user to regret a previous direction of motion of the limb.

In some embodiments, the delay is 1 second or less.

In some embodiments, the delay is 0.5 seconds or less.

In some embodiments, the at least two options comprise at least three options.

In some embodiments, the at least two options comprise at least four options.

In some embodiments, the at least two options are represented by graphic symbols.

In some embodiments, said graphic symbols are equally distributed on said display device.

In some embodiments, said displaying of the GUI menu is triggered in response to the user positioning the limb in a predetermined posture.

In some embodiments, said displaying of the GUI menu comprises displaying a cursor and correlating a motion of said cursor with the motion of the limb.

In some embodiments, the method further comprising forcing said cursor to an initial position at the center of said display device.

In some embodiments, the method further comprises providing a delay prior to said selecting of the first option, to enable the user to regret a previous direction of motion of the limb.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a block diagram of the system for rehabilitative treatment, in accordance with some embodiments;

FIG. 2 shows an example of a dedicated web page which summarizes information on a certain patient, in accordance with some embodiments;

FIG. 3 shows an example of a dedicated web page which is utilized by the therapist to construct a therapy plan for a certain patient, in accordance with some embodiments;

FIG. 4 shows an illustration of a structured light method for depth recognition, in accordance with some embodiments;

FIG. 5 shows a top view 2D illustration of a triangulation calculation used for determining a pixel depth, in accordance with some embodiments;

FIG. 6 shows an illustration of a human primary body parts and joints, in accordance with some embodiments;

FIG. 7 shows an example of one video game level screen shot, in accordance with some embodiments;

FIG. 8 shows an example of another video game level screen shot, in accordance with some embodiments;

FIG. 9 shows a block diagram of a system with a kinetic menu, in accordance with some embodiments; and

FIG. 10 shows an illustration of different operating states of the kinetic menu, in accordance with some embodiments.

### DETAILED DESCRIPTION

Disclosed herein is a system for computerized kinetic control, suitable for GUI (Graphic User Interface) menu activation and navigation within rehabilitative video games environment.

Conventionally, people who require rehabilitative therapy, such as accident victims who suffered physical damages and need physiotherapeutic treatment, elderly people who suffer from degenerative diseases, children who suffer from physically-limiting cerebral palsy, etc., arrive to a rehabilitation center, meet with a therapist who prescribes a therapy plan for them, and execute the plan at the rehabilitation center and/or at home. In many cases, the therapy plan comprises of repeatedly-performed physical exercises, with or without therapist supervision. The plan normally extends over multiple appointments, when in each appointment the therapist may monitor the patients progress and raise the difficulty level of the exercises. This conventional method has a few drawbacks: it requires the patient's arrival to the rehabilitation center, at least for a portion of the plan, which may be time consuming and difficult for some people (e.g. elderly people, small children, etc), it often involves repetitive and boring activity, which may lead to lack of motivation and abandonment of the plan, and may limit the therapist to treat a rather small number of patients.

Thus, allowing the executing a therapy plan in the form of a video game, at the convenience of the patients home, with easy communication between therapists and patients for plan prescribing and progress monitoring, may be highly advantageous to both therapists and patients. Moreover, combining the aforementioned advantages while providing for patient-specific video games, rather than generic video games, is also of great significance.

Nevertheless, the patients using these video games may still encounter problems when performing “administrative” actions, such as activating menus. Current menu activation within kinetic video games environment may not be adapted for this audience since it may often require a certain degree of movement accuracy, long static limb suspension, etc., which may be complicated to perform for these people. Hence, an easy to use system and method for activation and navigation GUI menus, adapted for the needs of rehabilitation patients, may be also advantageous.

### GLOSSARY

Video game: a game for playing by a human player, where the main interface to the player is visual content displayed using a monitor, for example. A video game may be executed by a computing device such as a personal computer (PC) or a dedicated gaming console, which may be connected to an output display such as a television screen, and to an input controller such as a handheld controller, a motion recognition device, etc.

Level of video game: a confined part of a video game, with a defined beginning and end. Usually, a video game includes multiple levels, where each level may involve a higher difficulty level and require more effort from the player.

Menu: presentation of options or commands to an operator by a computing device. Options provided in a menu may be selected by the operator by a number of methods (called interfaces), for example using a pointing device, a keyboard, a motion sensing device and/or the like.

Video game controller: a hardware part of a user interface (UI) used by the player to interact with the PC or gaming console.

Kinetic sensor: a type of a video game controller which allows the user to interact with the PC or gaming console by way of recognizing the user's body motion. Examples include handheld sensors which are physically moved by the user, body-attachable sensors, cameras which detect the user's motion, etc.

Motion recognition device: a type of a kinetic sensor, being an electronic apparatus used for remote sensing of a player's motions, and translating them to signals that can be input to the game console and used by the video game to react to the player motion and form interactive gaming.

Motion recognition game system: a system including a PC or game console and a motion recognition device.

Video game interaction: the way the user instructs the video game what he or she wishes to do in the game. The interaction can be, for example, mouse interaction, controller interaction, touch interaction, close range camera interaction or long range camera interaction.

Gesture: a physical movement of one or more body parts of a player, which may be recognized by the motion recognition device.

Exercise: a physical activity of a specific type, done for a certain rehabilitative purpose. An exercise may be comprised of one or more gestures. For example, the exercise referred to as “lunge”, in which one leg is moved forward abruptly, may be used to strengthen the quadriceps muscle, and the exercise referred to as “leg stance” is may be used to improve stability, etc.

Repetition (also “instance”): one performance of a certain exercise. For example, one repetition of a leg stance exercise includes gestures which begin with lifting one leg in the air, maintaining the leg in the air for a specified period of time, and placing the leg back on the ground.

Intermission: A period of time between two consecutive repetitions of an exercise, during which period the player may rest.

In accordance with present embodiments, a method for controlling a GUI (Graphic User Interface) menu may include: displaying, on a display device, a GUI menu comprising at least two options being disposed away from a center of the display device and at different polar angles relative to the center of the display device; detecting, using a kinetic sensor, motion of a limb of a user; and selecting a first option of the at least two options, wherein the selecting is based on a correspondence between a direction of the directional motion detected and a polar angle of the first option relative to the center of the display device.

The patient may activate the GUI menu, navigate and select an option while the motion recognition device captures his or her actions in a way that may allow the patient to see the actions on the screen, receive positive feedbacks for menu activation, option selection, etc. One example for a suitable motion recognition device is the Microsoft Corp. Kinect, a device for the Xbox 360 video game console and Windows PCs. Based around a webcam-style add-on peripheral for the Xbox 360 console, the Kinect enables users to control and interact with the Xbox 360 using a kinetic UI, without the need to touch a game controller, through a natural user interface using physical gestures.

The present system and method may also be adapted to other gaming consoles, such as Sony Playtation, Nintendo Wii, etc., and the motion recognition device may be a standard device for these or other gaming consoles.

Unless specifically stated otherwise, as apparent from the following discussions, it is appreciated that throughout the specification discussions utilizing terms such as “processing”, “computing”, “calculating”, “determining”, or the like, refer to the action and/or process of a computing system or a similar electronic computing device, that manipulate and/or transform data represented as physical, such as electronic, quantities within the computing system's registers and/or memories into other data similarly represented as physical quantities within the computing system's memories, registers or other such.

Some embodiments may be implemented, for example, using a computer readable medium or article which may store an instruction or a set of instructions that, if executed by a computer (for example, by a hardware processor and/or by other suitable machines), cause the computer to perform a method and/or operations in accordance with embodiments of the invention. Such a computer may include, for example, any suitable processing platform, computing platform, computing device, processing device, computing system, processing system, computer, processor, gaming console or the like, and may be implemented using any suitable combination of hardware and/or software. The computer-readable medium or article may include, for example, any type of disk including floppy disks, optical disks, CD-ROMs, magnetic-optical disks, read-only memories (ROMs), random access memories (RAMs), flash memories, electrically programmable read-only memories (EPROMs), electrically erasable and programmable read only memories (EEPROMs), magnetic or optical cards, or any other type of media suitable for storing electronic instructions, and capable of being coupled to a computer system bus.

The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, such as C, C++, C#, Java, BASIC, Pascal, Fortran, Cobol, assembly language, machine code, or the like.

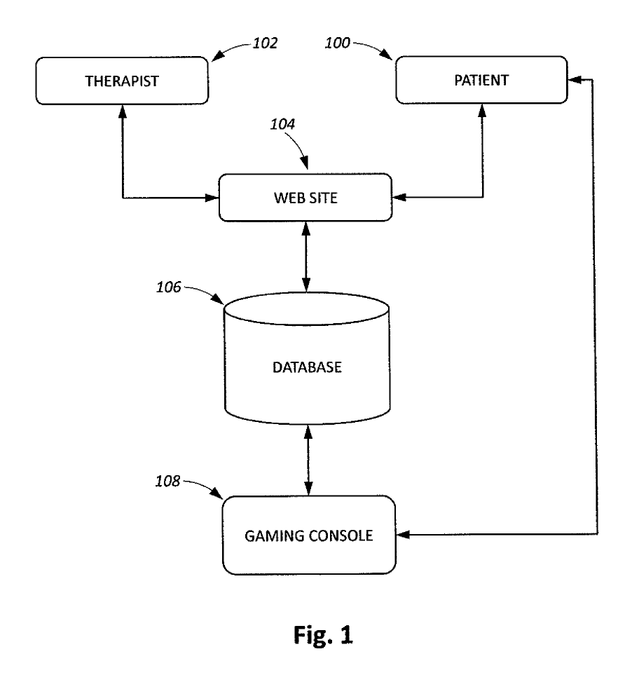

The present system and method may be better understood with reference to the accompanying figures. Reference is now made to FIG. 1, which shows a block diagram of the system for rehabilitative treatment. The therapist 102 may logon to the dedicated web site 104, communicate with patients 100, prescribe therapy plans (also referred to as “prescriptions” or “treatment plans”), and monitor patient progress. Web site 104 may receive the prescribed plan and store it in a dedicated database 106. The therapy plan than may be automatically translated to a video game level. When patient 100 activates his or her video game, the new level, or instructions for generating the new level, may be downloaded to his or her gaming console 108 and he or she may play this new level. Since the game may be interactive, the motion recognition device may monitor the patient movements for storing patient results and progress, and or for providing real time feedback during the game play, such as in the form of score accumulation. The results, in turn, may be sent to database 106 for storage and may be available for viewing on web site 104 by therapist 102 for monitoring patient 100 progress, and to patient 100 for receiving feedback.

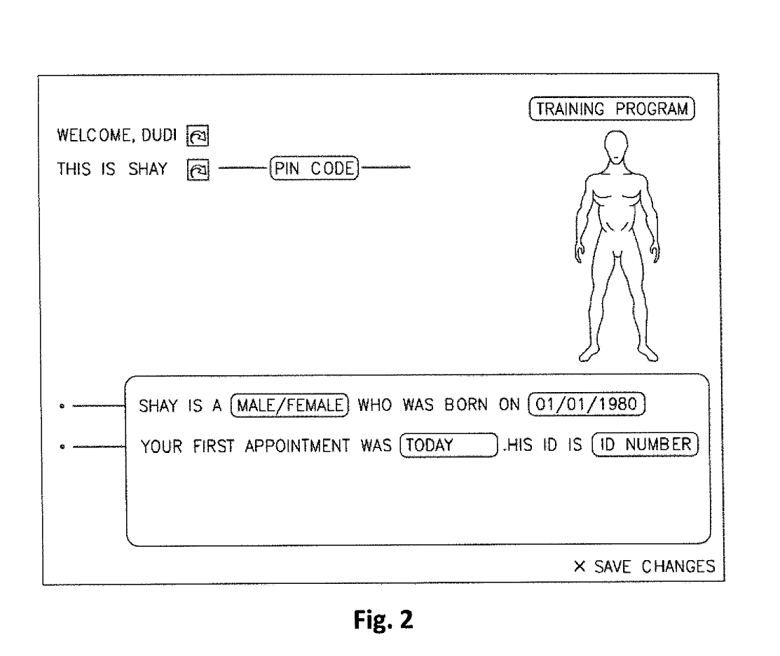

Reference is now made to FIG. 2, which shows an example of a dedicated web site page which summarizes information on a certain patient for the therapist. The page may display a summary of the patient profile, appointments history, diagnosis, other therapists comment history, etc.

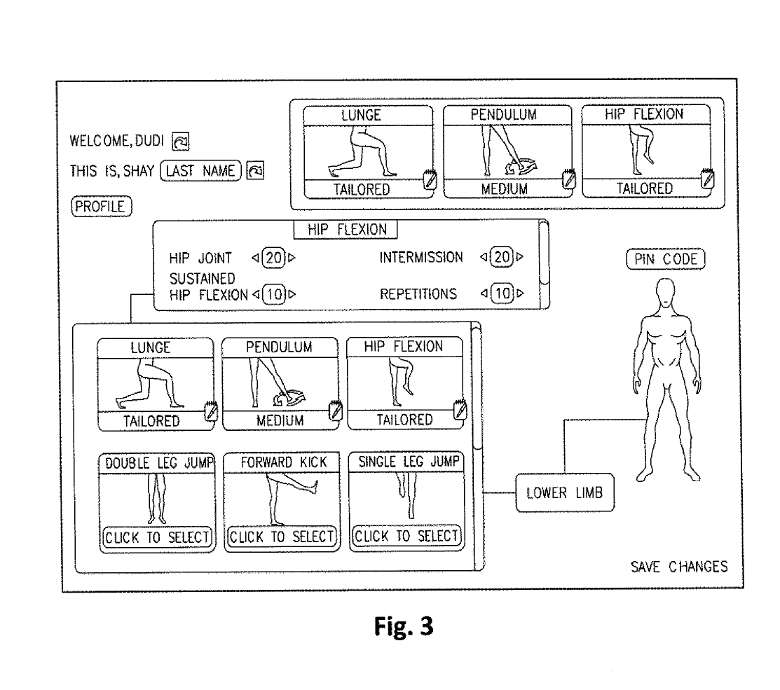

Reference is now made to FIG. 3, which shows an example of a dedicated web site page which is utilized by the therapist to construct a therapy plan for a certain patient. The therapist may input the required exercises, repetition number, difficulty level, etc. Since the use of motion recognition device may be significant for the present method, the principle of operation of a commercially-available motion recognition device (Kinect) and its contribution to the method is described hereinafter.

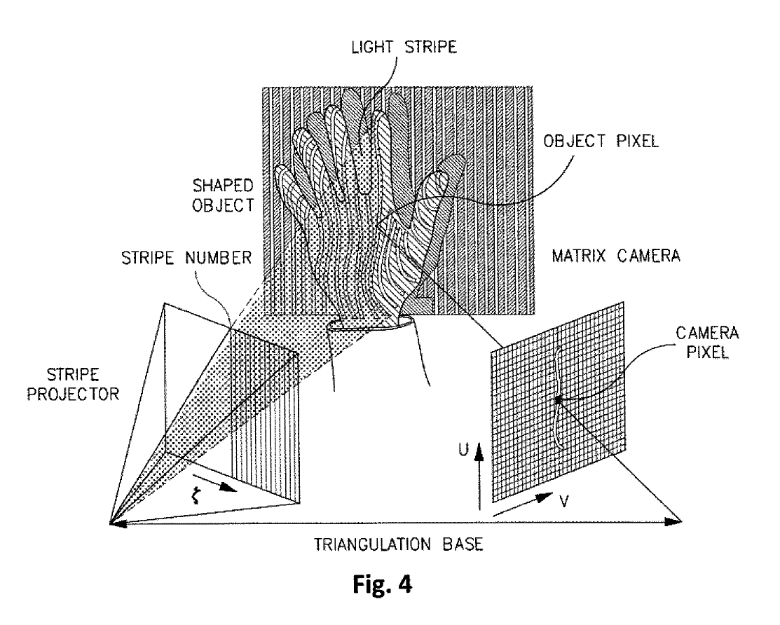

Reference is now made to FIG. 4, which shows an illustration of a structured light method for depth recognition. A projector may be used for projecting the scene with known stripe-like light pattern. The projected object may distort the light pattern with equivalency to its shape. A camera, which may be installed at a known distance from the projector, may then capture the light reflected from the object and sense the distortion that may be formed in the light pattern, and the angle of the reflected light, for each pixel of the image.

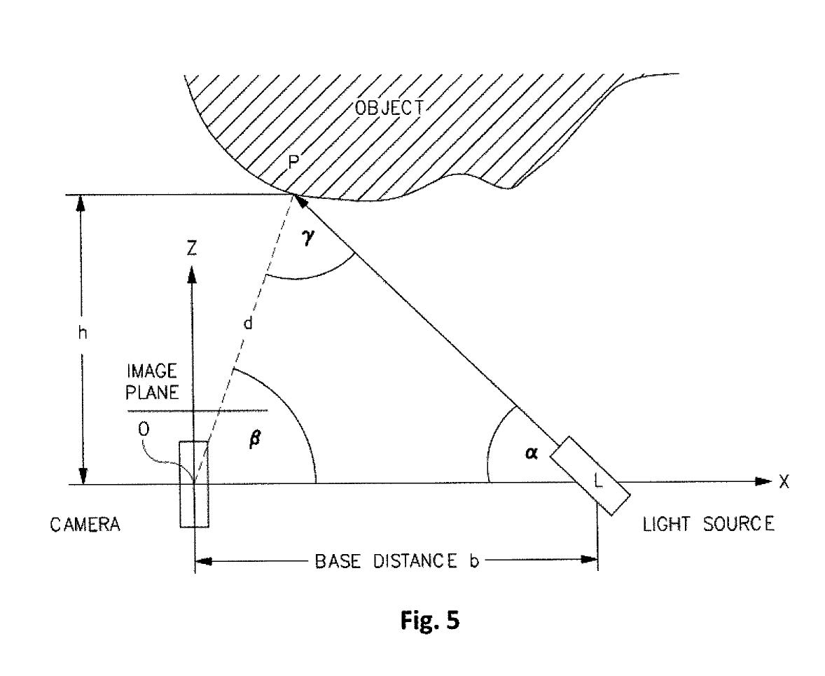

Reference is now made to FIG. 5, which shows a top view 2D illustration of a triangulation calculation used for determining a pixel depth. The camera may be located in a known distance from the light source (b). P is a point on the projected object which coordinates are to be calculated. According to the law of sines:

$$\frac{d}{sin α} = \frac{b}{sin γ} {\to }^{ yields } d = \frac{b \cdot sin α}{sin γ} = \frac{b \cdot α}{sin π - α - β} = \frac{b \cdot α}{sin α + {β}^{′}}$$

and P coordinates are given by (d cos β, d sin β). Since a and b are known, and β is defined by the projective geometry, P coordinates may be resolved. The above calculation is made for 2D for the sake of simplicity, but the real device may actually calculate a 3D solution for each pixel coordinates to form a complete depth image of the scene, which may be utilized to recognize human movements.

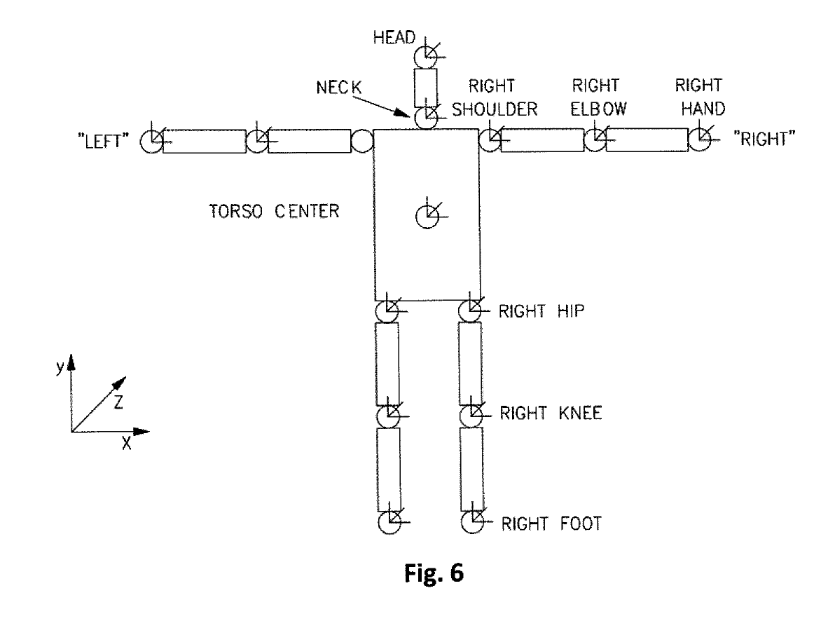

Reference is now made to FIG. 6, which shows an illustration of human primary body parts and joints. By recognizing the patient body parts and joints movements, the discussed method may enable to analyze the patient gestures and responses to the actions required by the game, for yielding an immediate feedback for the patient, and for storage for future analysis by the therapist.

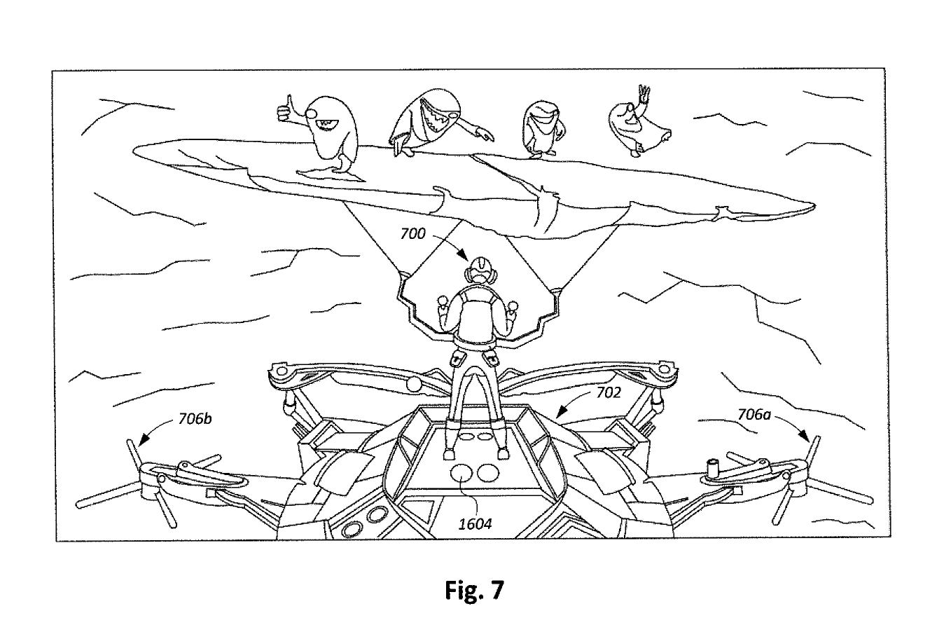

Reference is now made to FIG. 7, which shows one example of a video game level screen shot. This specific level may be designed to include squats, hinges, kicks, leg pendulums, etc. The patient may see a character 700 performing his own movements at real time. Character 700 may stand on a moving vehicle 702, which may accelerate when the patient is performing squats, and may slow when the patient hinges. Some foot spots 704 may be depicted on vehicle 702 platform and may be dynamically highlighted, in order to guide the patient to place his feet in the correct positions while performing the squats, hinges, kicks, etc. Right rotating device 706a and left rotating device 706b may be depicted on the right and left sides of vehicle 702, to form a visual feedback for the patient while performing leg pendulum exercises.

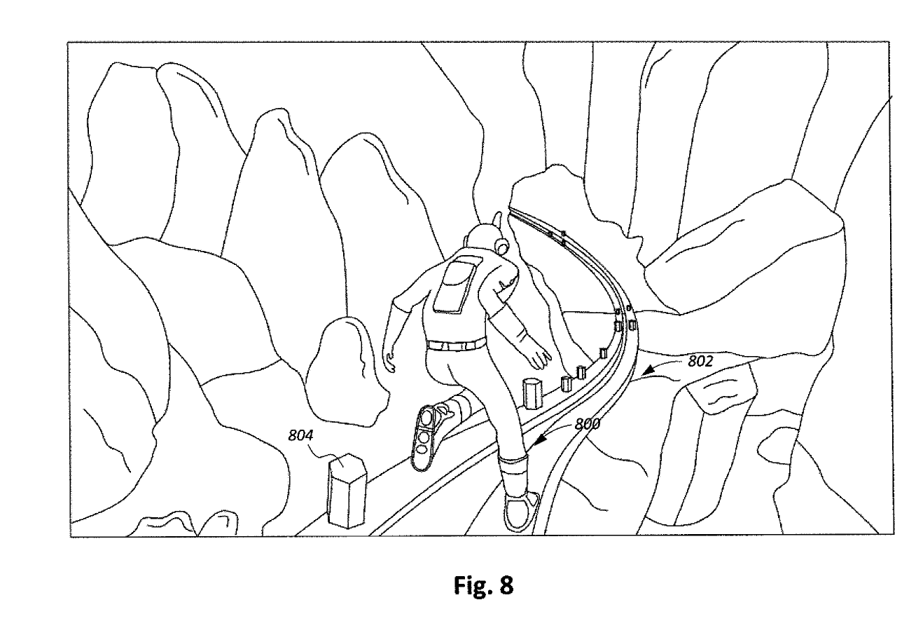

Reference is now made to FIG. 8, which shows another example of a video game level screen shot. This specific level may be designed to include hip flexions, leg stances and jumps, etc. The patient may see a character 800 performing his own movements at real time. Character 800 may advance on a rail 802 planted with obstacles 804. The patient may need to perform actions such as hip flexion, leg jump, etc., to avoid the obstacles and/or collect objects.

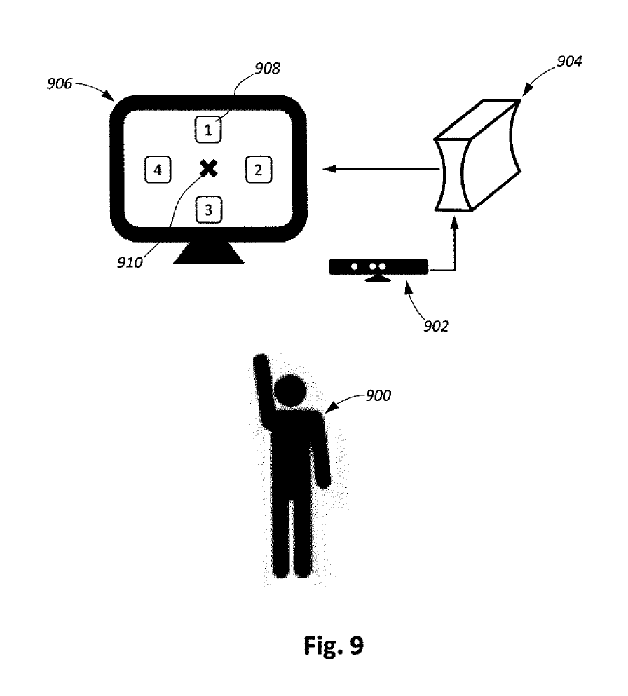

Reference is now made to FIG. 9, which shows a block diagram of the system with a kinetic menu. A patients 900 gestures may be monitored by motion recognition device (e.g. Kinect) 902, which, in turn, may compute a depth image of patient 900.

The depth image may then be transferred to a computing device such as a gaming console 904, which may compute and translate patient 900 gestures to activation of a menu. The menu may be displayed on a display 906 and may include at least two options 908 for choice (by example herein are four options numbered 1, 2, 3, and 4), and a cursor 910 which may show the current pointing of patient 900. Choice options 908 may be displayed at a certain distance from display 906 center, and at different polar angles relative to display 906 center. By way of example herein, all four choice options may be at equal distance from display center, while option 1 may be at 0°, option 2 may be at 90°, option 3 may be at 180°, and option 4 may be at 270° (namely, a cross configuration). In other embodiments (not shown), there are five options shown. In further embodiments, there are six or more options shown.

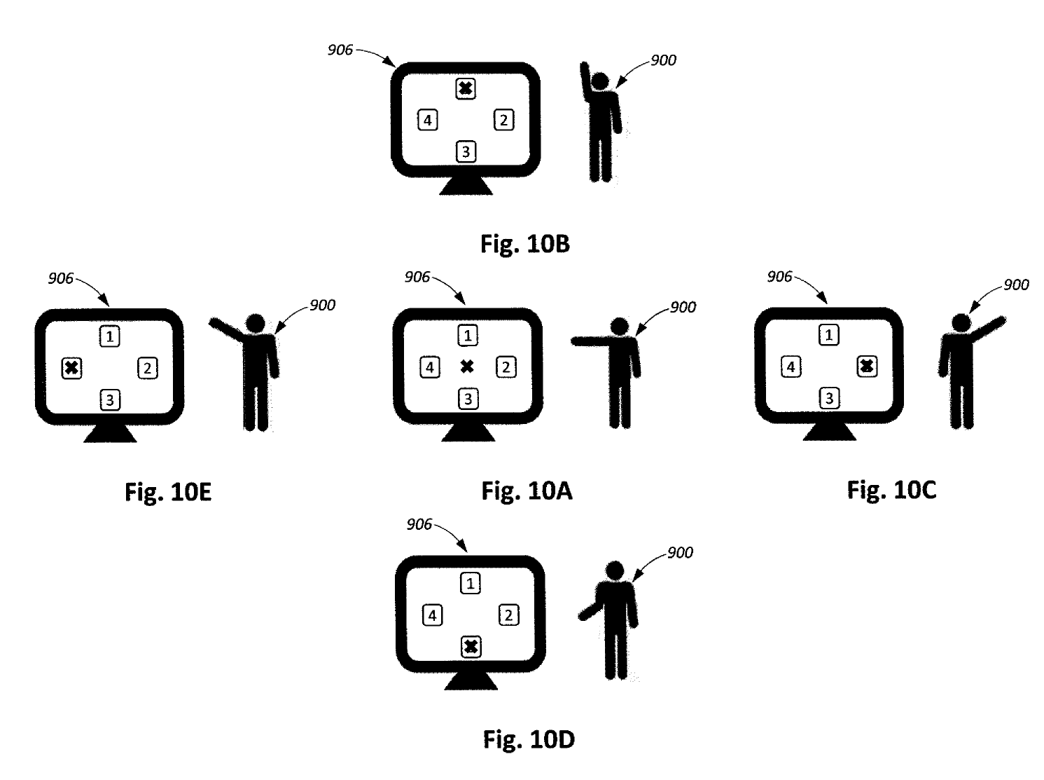

Reference is now made to FIG. 10, which shows an illustration of the kinetic menu different operating states. All figures show actions of patient 900 and their visible outcomes on display 906. FIG. 10A shows an activation of the kinetic menu. Patient 900 may perform a pre-determined gesture (e.g. stand upright and extend one of his arms straight forward). As a result, cursor 910 may appear on display 906 center, providing feedback to patient 900 that his action to activate menu was received by the system. Activation of menu may be done at any stage of the gaming activity. After cursor 910 has appeared, it may move on display 906 with correlation to patient 900 hand movements. FIG. 10B shows a selection of top choice option 908 (herein numbered 1). Patient 900 may move his or her hand upward, in order to move cursor 910 to point on option 1. FIG. 10C shows a selection of right choice option 908 (herein numbered 2). Patient 900 may move his or her hand rightward, in order to move cursor 910 to point on option 2. FIG. 10D shows a selection of bottom choice option 908 (herein numbered 3). Patient 900 may move his or her hand downward, in order to move cursor 910 to point on option 3. FIG. 10E shows a selection of left choice option 908 (herein numbered 4). Patient 900 may move his or her hand leftward, in order to move cursor 910 to point on option 4. After cursor 910 stays on a certain option for pre-determined duration (e.g. 0.5 or 1 second), the system may assume that patient 900 intended to choose that option, and may execute it. At any stage, if patient 900 eliminates the pre-determined gesture which activated the kinetic menu activation (e.g. put his or her hand down), the kinetic menu may disappear.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

What is claimed is:

1. A computerized kinetic control system comprising:
a kinetic sensor;
a display device; and
a hardware processor configured to:
(a) display, using said display device, a GUI (Graphic User Interface) menu comprising at least two options being disposed away from a center of said display device and at different polar angles relative to the center of said display device,
(b) detect, using said kinetic sensor, motion of a limb of a user, and
(c) select a first option of the at least two options, wherein the selecting is based on a correspondence between a direction of the motion detected and a polar angle of the first option relative to the center of the display device.

2. The system according to claim 1, wherein said kinetic sensor is a motion-sensing camera.

3. The system according to claim 1, wherein said hardware processor is further configured to trigger the display of the GUI menu responsive to the user positioning the limb in a predetermined posture.

4. The system according to claim 3, wherein said hardware processor is further configured to display a cursor in said GUI menu and to correlate a motion of the cursor with the motion of the limb.

5. The system according to claim 4, wherein said hardware processor is further configured to three the display of the cursor to be at an initial position at the center of said display device.

6. The system according to claim 4, wherein the limb is an arm.

7. The system according to claim 6, wherein the predetermined posture comprises standing upright and extending the arm straight forward.

8. The system according to claim 1, wherein said hardware processor is further configured to select the first option following a delay provided to enable the user to regret a previous direction of motion of the limb.

9. The system according to claim 8, wherein the delay is 1 second or less.

10. (canceled)

11. (canceled)

12. The system according to claim 1, wherein the at least two options comprise at least four options.

13. (canceled)

14. The system according to claim 13, wherein said graphic symbols are equally distributed on said display device.

15. A method for controlling a GUI (Graphic User interface) menu, the method comprising using at least one hardware processor for:
displaying, on a display device, a GUI menu comprising at least two options being disposed away from a center of the display device and at different polar angles relative to the center of the display device;
detecting, using a kinetic sensor, motion of a limb of a user; and
selecting a first option of the at least two options, wherein the selecting is based on a correspondence between a direction of the directional motion detected and a polar angle of the first option relative to the center of the display device, wherein said displaying of the GUI menu is triggered in response to the user positioning the limb in a predetermined posture.

16. The method according to claim 15, wherein said displaying of the GUI menu comprises displaying a cursor and correlating a motion of said cursor with the motion of the limb.

17. The method according to claim 16, further comprising forcing said cursor to an initial position at the center of said display device.

18. The method according to claim 16, wherein the limb is an arm.

19. The method according to claim 18, wherein the predetermined post comprises standing upright and extending the arm straight forward.

20. The method according to claim 14, further comprising providing a delay prior to said selecting of the first option, to enable the user to regret a previous direction of motion of the limb.

21. The method according to claim 20, wherein the delay is 1 second or less.

22. (canceled)

23. (canceled)

24. (canceled)

25. (canceled)

26. (canceled)

27. The system according to claim 1, wherein said hardware processor is further configured to select the first option based on the correspondence between a direction of the motion detected and the polar angle of the first option relative to a reference axis extending from the center of the display device.

28. The method according to claim 15, wherein said correspondence is between a direction of the directional motion detected and a polar angle of the first option relative to a reference axis extending from the center of the display device.
